(19) United States
(12) Patent Application Publication
(10) Pub. No.: US 2004/0164448 A1
(43) Pub. Date: Aug. 26, 2004

(54) Method of producing a polymer body by coalescence and the polymer body produced

(76) Inventors: Kent Al Olsson, Stockholm (SE); Jianguo Li, Huddinge (SE)

Correspondence Address: Karin Larsson, Albhins Stockholm AB, Box 5581, Stockholm, 114 85, SE

(21) Appl. No.: 10/343,086

(22) PCT Filed: Jul. 25, 2001
(86) PCT No.: PCT/SE01/01671

(51) Int. Cl. B27N 3/08

(52) U.S. Cl. 264/239

(57) ABSTRACT

A method of producing a polymer body by coalescence, wherein the method comprises the steps of a) filling a pre-compacting mould with polymer material in the form of powder, pellets, grains and the like, b) pre-compacting the material at least once and c) compressing the material in a compression mould by at least one stroke, where a striking unit emits enough kinetic energy to form the body when striking the material inserted in the compression mould, causing coalescence of the material. A method of producing a polymer body by coalescence, wherein the method comprises compressing material in the form of a solid polymer body in a compression mould by at least one stroke, where a striking unit emits enough energy to cause coalescence of the material in the body. Products obtained by the inventive methods.

The invention concerns a method of producing a polymer body by coalescence as well as the polymer body produced by this method.

### STATE OF THE ART

In WO-A1-9700751, an impact machine and a method of cutting rods with the machine is described. The document also describes a method of deforming a metal body. The method utilises the machine described in the document and is characterised in that preferably metallic material either in solid form or in the form of powder such as grains, pellets and the like, is fixed preferably at the end of a mould, holder or the like and that the material is subjected to adiabatic coalescence by a striking unit such as an impact ram, the motion of the ram being effected by a liquid. The machine is thoroughly described in the WO document.

In WO-A1-9700751, shaping of components, such as spheres, is described. A metal powder is supplied to a tool divided in two parts, and the powder is supplied through a connecting tube. The metal powder has preferably been gas-atomized. A rod passing through the connecting tube is subjected to impact from the percussion machine in order to influence the material enclosed in the spherical mould. However, it is not shown in any embodiment specifying parameters for how a body is produced according to this method.

The compacting according to this document is performed in several steps, e.g. three. These steps are performed very quickly and the three strokes are performed as described below.

Stroke 1: an extremely light stroke, which forces out most of the air from the powder and orients the powder particles to ensure that there are no great irregularities.

Stroke 2: a stroke with very high energy density and high impact velocity, for local adiabatic coalescence of the powder particles so that they are compressed against each other to extremely high density. The local temperature increase of each particle is dependent on the degree of deformation during the stroke.

Stroke 3: a stroke with medium-high energy and with high contact energy for final shaping of the substantially compact material body. The compacted body can thereafter be sintered.

In SE 9803956-3 a method and a device for deformation of a material body are described. This is substantially a development of the invention described in WO-A1-9700751. In the method according to the Swedish application, the striking unit is brought to the material by such a velocity that at least one rebounding blow of the striking unit is generated, wherein the rebounding blow is counteracted whereby at least one further stroke of the striking unit is generated.

The strokes according to the method in the WO document, give a locally very high temperature increase in the material, which can lead to phase changes in the material during the heating or cooling. When using the counteracting of the rebounding blows and when at least one further stroke is generated, this stroke contributes to the wave going back and forth and being generated by the kinetic energy of the first stroke, proceeding during a longer period. This leads to further deformation of the material and with a lower impulse than would have been necessary without the counteracting. It has now shown that the machine according to these mentioned documents does not work so well. For example are the time intervals between the strokes, which they mention, not possible to obtain. Further, the document does not comprise any embodiments showing that a body can be formed.

### OBJECT OF THE INVENTION

The object of the present invention is to achieve a process for efficient production of products from polymer at a low cost. These products may be both medical devices such as medical implants or bone cement in orthopaedic surgery, instruments or diagnostic equipment, or non medical devices such as sinks, baths, displays, glazing (especially aircraft), lenses and light covers. Another object is to achieve a polymer product of the described type.

It should also be possible to perform the new process at a much lower velocity than the processes described in the above documents. Further, the process should not be limited to using the above described machine.

### SHORT DESCRIPTION OF THE INVENTION

It has surprisingly been found that it is possible to compress different polymers according to the new method defined in claim 1. The material is for example in the form of powder, pellets, grains and the like and is filled in a mould, pre-compacted and compressed by at least one stroke. The machine to use in the method may be the one described in WO-A1-9700751 and SE 9803956-3.

The method according to the invention utilises hydraulics in the percussion machine, which may be the machine utilised in WO-A1-9700751 and SE 9803956-3. When using pure hydraulic means in the machine, the striking unit can be given such movement that, upon impact with the material to be compressed, it emits sufficient energy at sufficient speed for coalescence to be achieved. This coalescence may be adiabatic. A stroke is carried out quickly and for some materials the wave in the material decay in between 5 and 15 milliseconds. The hydraulic use also gives a better sequence control and lower running costs compared to the use of compressed air. A spring-actuated percussion machine will be more complicated to use and will give rise to long setting times and poor flexibility when integrating it with other machines. The method according to the invention will thus be less expensive and easier to carry out. The optimal machine has a large press for pre-compacting and post-compacting and a small striking unit with high speed. Machines according to such a construction are therefore probably more interesting to use. Different machines could also be used, one for the pre-compacting and post-compacting and one for the compression.

### SHORT DESCRIPTION OF THE DRAWINGS

On the enclosed drawings

FIG. 1 shows a cross sectional view of a device for deformation of a material in the form of a powder, pellets, grains and the like, and

FIGS. 2-18 are diagrams showing results obtained in the embodiments described in the examples.

### DETAILED DESCRIPTION OF THE INVENTION

The invention concerns a method of producing a polymer body by coalescence, wherein the method comprises the steps of

a) filling a pre-compacting mould with polymer material in the form of powder, pellets, grains and the like,

b) pre-compacting the material at least once and

c) compressing the material in a compression mould by at least one stroke, where a striking unit emits enough kinetic energy to form the body when striking the material inserted in the compression mould, causing coalescence of the material.

The pre-compacting mould may be the same as the compression mould, which means that the material does not have to be moved between the step b) and c). It is also possible to use different moulds and move the material between the steps b) and c) from the pre-compacting mould to the compression mould. This could only be done if a body is formed of the material in the pre-compacting step.

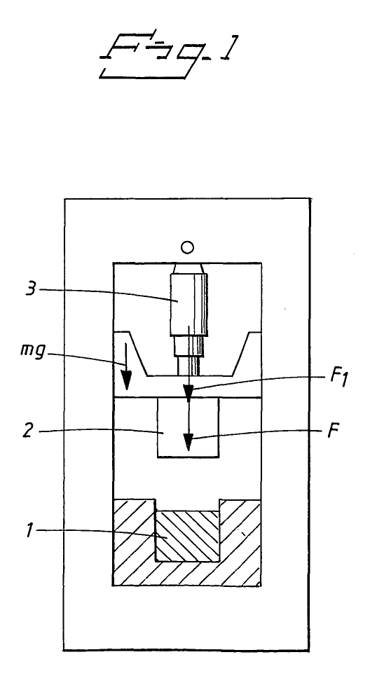

The device in FIG. 1 comprises a striking unit 2. The material in FIG. 1 is in the form of powder, pellets, grains or the like. The device is arranged with a striking unit 3, which with a powerful impact may achieve an immediate and relatively large deformation of the material body 1. The invention also refers to compression of a body, which will be described below. In such a case, a solid body 1, such as a solid homogeneous polymer body, would be placed in a mould.

The striking unit 2 is so arranged, that, under influence of the gravitation force, which acts thereon, it accelerates against the material 1. The mass m of the striking unit 2 is preferably essentially larger than the mass of the material 1. By that, the need of a high impact velocity of the striking unit 2 can be reduced somewhat. The striking unit 2 is allowed to hit the material 1, and the striking unit 2 emits enough kinetic energy to compact and form the body when striking the material in the compression mould. This causes a local coalescence and thereby a consequent deformation of the material 1 is achieved. The deformation of the material 1 is plastic and consequently permanent. Waves or vibrations are generated in the material 1 in the direction of the impact direction of the striking unit 2. These waves or vibrations have high kinetic energy and will activate slip planes in the material and also cause relative displacement of the grains of the powder. It is possible that the coalescence may be an adiabatic coalescence. The local increase in temperature develops spot welding (inter-particular melting) in the material which increases the density.

The pre-compaction is a very important step. This is done in order to drive out air and orient the particles in the material. The pre-compaction step is much slower than the compression step, and therefore it is easier to drive out the air. The compression step, which is done very quickly, may not have the same possibility to drive out air. In such case, the air may be enclosed in the produced body, which is a disadvantage. The pre-compaction is performed at a minimum pressure enough to obtain a maximum degree of packing of the particles which results in a maximum contact surface between the particles. This is material dependent and depends on the softness and melting point of the material.

The pre-compacting step in the Examples has been performed by compacting with about 117680 N axial load. This is done in the pre-compacting mould or the final mould. According to the examples in this description, this has been done in a cylindrical mould, which is a part of the tool, and has a circular cross section with a diameter of 30 mm, and the area of this cross section is about 7 cm². This means that a pressure of about 1.7×10⁸ N/m² has been used. For UHMWPE the material may be pre-compacted with a pressure of at least about 0.25×10⁸ N/m², and preferably with a pressure of at least about 0.6×10⁸ N/m². The necessary or preferred pre-compaction pressure to be used is material dependent and for a softer polymer it could be enough to compact at a pressure of about 2000 N/m². Other possible values are 1.0×10⁸ N/m², 1.5×10⁸ N/m². The studies made in this application are made in air and at room temperature. All values obtained in the studies are thus achieved in air and room temperature. It may be possible to use lower pressures if vacuum or heated material is used. The height of the cylinder is 60 mm. In the claims is referred to a striking area and this area is the area of the circular cross section of the striking unit which acts on the material in the mould. The striking area in this case is the cross section area.

In the claims it is also referred to the cylindrical mould used in the Examples. In this mould the area of the striking area and the area of the cross section of the cylindrical mould are the same. However, other constructions of the moulds could be used, such as a spherical mould. In such a mould, the striking area would be less than the cross section of the spherical mould.

The invention further comprises a method of producing a polymer body by coalescence, wherein the method comprises compressing material in the form of a solid polymer body (i.e. a body where the target density for specific applications has been achieved) in a compression mould by at least one stroke, where a striking unit emits enough energy to cause coalescence of the material in the body. Slip planes are activated during a large local temperature increase in the material, whereby the deformation is achieved. The method also comprises deforming the body.

The method according to the invention could be described in the following way. 1) Powder is pressed to a green body, the body is compressed by impact to a (semi) solid body and thereafter an energy retention may be achieved in the body by a post-compacting. The process, which could be described as Dynamic Forging Impact Energy Retention (DFIER) involves three mains steps.

a) Pressuring

The pressing step is very much like cold and hot pressing. The intention is to get a green body from powder. It has turned out to be most beneficial to perform two compactions of the powder. One compaction alone gives about 2-3% lower density than two consecutive compactions of the powder. This step is the preparation of the powder by evacuation of the air and orientation of the powder particles in a beneficial way. The density values of the green body is more or less the same as for normal cold and hot pressuring.

b) Impact

The impact step is the actual high-speed step, where a striking unit strikes the powder with a defined area. A material wave starts off in the powder and interparticular melting takes place between the powder particles. Velocity of the striking unit seems to have an important role only during a very short time initially. The mass of the powder and the properties of the material decides the extent of the intelparticular melting taking place.

c) Energy retention

The energy retention step aims at keeping the delivered energy inside the solid body produced. It is physically a compaction with at least the same pressure as the pre-compaction of the powder. The result is an increase of the density of the produced body by about 1-2%. It is performed by letting the striking unit stay in place on the solid body after the impact and press with at least the same pressure as at pre-compaction, or release after the impact step. The idea is that more transformations of the powder will take place in the produced body.

According to the method, the compression strokes emit a total energy corresponding to at least 100 Nm in a cylindrical tool having a striking area of 7 cm2 in air and at room temperature. Other total energy levels may be at least 300, 600, 1000, 1500, 2000, 2500, 3000 and 3500 Nm. Energy levels of at least 10 000, 20 000 Nm may also be used. There is a new machine, which has the capacity to strike with 60 000 Nm in one stroke. Of course such high values may also be used. And if several such strikes are used, the total amount of energy may reach several 100 000 Nm. The energy levels depend on the material used, and in which application the body produced will be used. Different energy levels for one material will give different relative densities of the material body. The higher energy level, the more dense material will be obtained. Different material will need different energy levels to get the same density. This depends on for example the hardness of the material and the melting point of the material.

According to the method, the compression strokes emit an energy per mass corresponding to at least 5 Nm/g in a cylindrical tool having a striking area of 7 cm2 in air and at room temperature. Other energies per mass may be at least 20 Nm/g, 50 Nm/g, 100 Nm/g, 150 Nm/g, 200 Nm/g, 250 Nm/g, 350 Nm/g and 450 Nm/g.

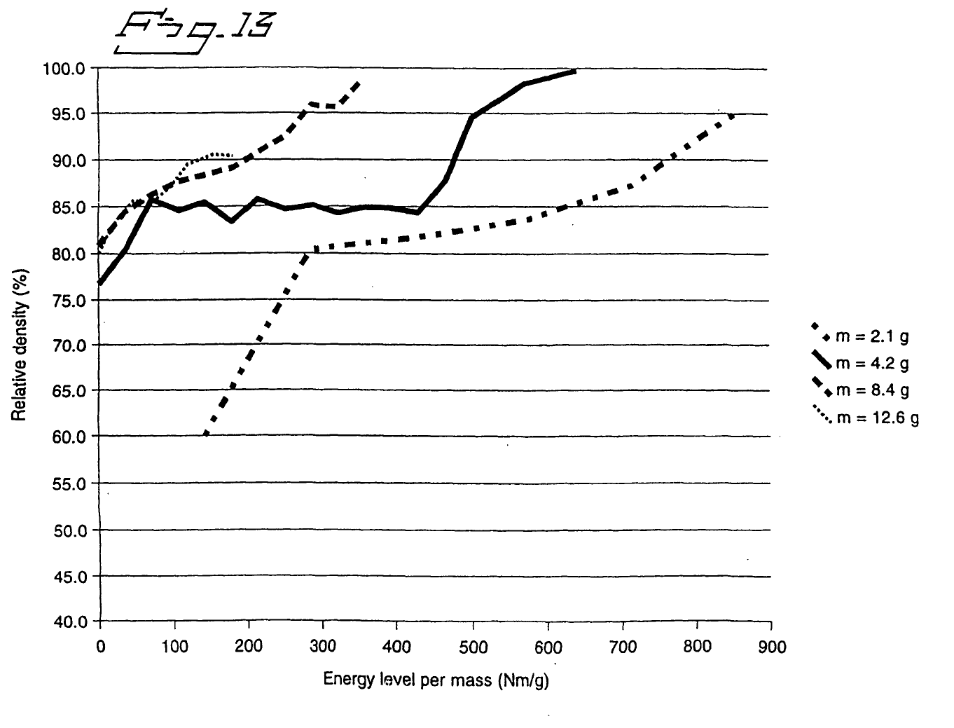

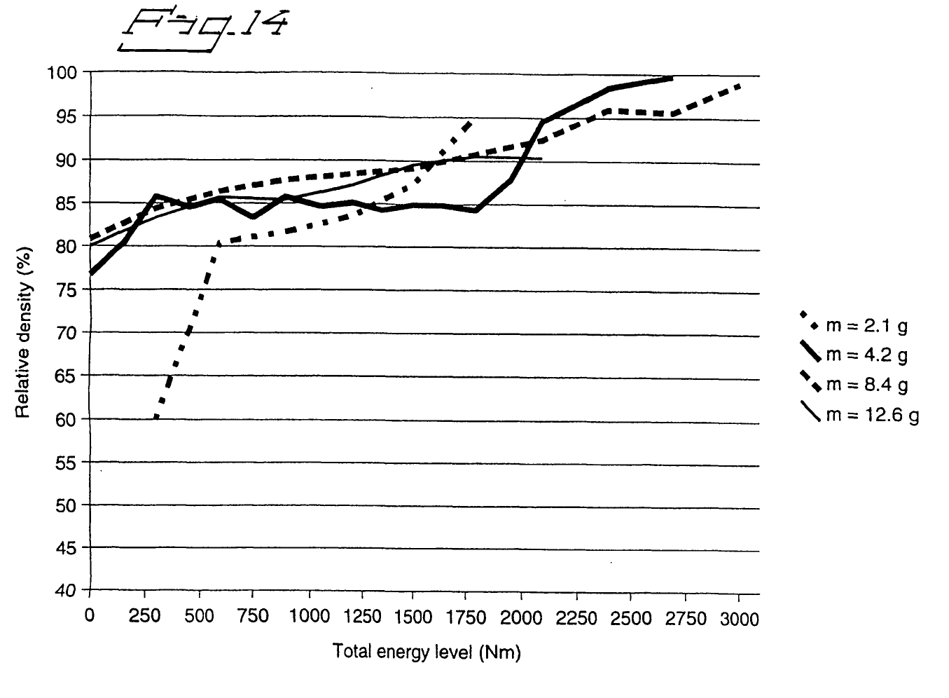

With the same energy per mass the relative density will reach a higher level for a greater mass and a lower for a smaller mass. The difference between these relative densities of different masses is biggest with lower energies per mass. This is shown in a mass parameter study for UHMWPE in the Examples, and can be shown in FIG. 13 where the relative density as a function of impact energy per mass is shown. For the sample of 2×4.2 g, a higher density is obtained for lower energy per mass, compared to the sample of 0.5×4.2 g, which gets a lower density at the same energy per mass. It can also be seen in FIG. 14, where the relative density as a function of the total impact energy is shown. For the mass of 2×4.2 g is seen, that for a relative density of about 85% is obtained at a total energy of 500 Nm, corresponding to 60 Nm/g. The total energy needed for the sample of 0.5×4.2 g to obtain a relative density of 85% is about 1250 Nm, corresponding to 595 Nm/g. Thus, a lower energy per mass is needed for the higher mass to obtain the same relative density.

For the samples tested in the Examples in the mass parameter study, the result is the following. When essentially higher densities are obtained, the method is not depending on the energy per mass, but the total energy seems to be independent of the mass. Thus, the same total energy for the compression strokes gives about the same density for a produced body irrespective of the weight. In FIG. 14, the graphs for all the masses are separated for essentially low densities and they are getting closer to each other at essentially higher densities. Thus, for the weight interval measured and for UHMWPE the total energy is independent of the mass at higher densities. This is shown for UHMWPE and the limit between the separation of the curves and the meeting of the curves, or high and low densities, are about 90-95%, and the total energy is about 2000 Nm at 90-95% for UHMWPE.

These values will vary dependent on what material is used. A person skilled in the art will be able to test at what values the mass dependency will be valid and when the mass independence will start to be valid. The changeover of the densities from the lower to higher densities will vary depending on the material. These values are approximate.

The energy level needs to be amended and adapted to the form and construction of the mould. If for example, the mould is spherical, another energy level will be needed. A person skilled in the art will be able to test what energy level is needed with a special form, with the help and direction of the values given above. The energy level depends on what the body will be used for, i.e. which relative density is desired, the geometry of the mould and the properties of the material. The striking unit must emit enough kinetic energy to form a body when striking the material inserted in the compression mould. With a higher velocity of the stroke, more vibrations, increased friction between particles, increased local heat, and increased interparticular melting of the material will be achieved. The bigger the stroke area is, the more vibrations are achieved. There is a limit where more energy will be delivered to the tool than to the material. Therefore, there is also an optimum for the height of the material.

When a powder of a polymer material is inserted in a mould and the material is struck by a striking unit, a coalescence is achieved in the powder material and the material will float. A probable explanation is that the coalescence in the material arises from waves being generated back and forth at the moment when the striking unit rebounds from the material body or the material in the mould. These waves give rise to a kinetic energy in the material body. Due to the transmitted energy a local increase in temperature occurs, and enables the particles to soften, deform and the surface of the particles will melt. The inter-particular melting enables the particles to re-solidify together and dense material can be obtained. This also affects the smoothness of the body surface. The more a material is compressed by the coalescence technique, the smoother surface is obtained. The porosity of the material and the surface is also affected by the method. If a porous surface or body is desired, the material should not be compressed as much as if a less porous surface or body is desired.

The individual strokes affect material orientation, driving out air, pre-moulding, coalescence, tool filling and final calibration. It has been noted that the back and forth going waves travels essentially in the stroke direction of the striking unit, i.e. from the surface of the material body which is hit by the striking unit to the surface which is placed against the bottom of the mould and then back.

What has been described above about the energy transformation and wave generation also refer to a solid body. In the present invention a solid body is a body where the target density for specific applications has been achieved.

The striking unit preferably has a velocity of at least 0.1 m/s or at least 1.5 m/s during the stroke in order to give the impact the required energy level. Much lower velocities may be used than according to the technique in the prior art. The velocity depends on the weight of the striking unit and what energy is desired. The total energy level in the compression step is at least about 100 to 4000 Nm. But much higher energy levels may be used. By total energy is meant the energy level for all strokes added together. The striking unit makes at least one stroke or a number of consecutive strokes. The interval between the strokes according to the Examples was 0.4 and 0.8 seconds. For example at least two strikes may be used. According to the Examples one stroke has shown promising results. These Examples were performed in air and at room temperature. If for example vacuum and heat or some other improving treating is used, perhaps even lower energies may be used to obtain good relative densities.

The polymer may be compressed to a relative density of 70%, preferably 75%. More preferred relative densities are also 80% and 85%. Other preferred densities are 90 to 100%. However, other relative densities are also possible. If a green body is to be produced, it could be enough with a relative density of about 50-60%. Low bearing implant desires a relative density of 90 to 100% and in some biomaterials it is good with some porosity. If a porosity of above 95% is obtained and this is sufficient for the use, no further post-processing is necessary. This may be the choice for certain applications. If a relative density of less than 95% is obtained, and this is not enough, the process need to continue with further processing such as sintering. Several manufacturing steps have even in this case been cut compared to conventional manufacturing methods.

The method also comprises pre-compacting the material at least twice. It has been shown in the Examples that this could be advantageous in order to get a high relative density compared to strokes used with the same total energy and only one pre-compacting. Two compactions give about 1-5% higher density than one compacting depending on the material used. The increase may be even higher for other materials. When pre-compacting twice, the compacting steps are performed with a small interval between, such as about 5 seconds. About the same pressure may be used in the second pre-compacting.

Further, the method may also comprise a step of compacting the material at least once after the compression step. This has also been shown to give very good results. The post-compacting should be carried out at at least the same pressure as the pre-compacting pressure, i.e. 2000 N/m². Other possible values are 1.0×10⁸ N/m². Higher post-compacting pressures may also be desired, such as a pressure which is twice the pressure of the pre-compacting pressure. For UHMWPE the pre-compacting pressure should be at least about 0.25 N/m² and this would be the lowest possible post-compacting pressure for UHMWPE. The pre-compacting value has to be tested out for every material. A post-compacting effects the sample differently than a pre-compacting. The transmitted energy, which increases the local temperature between the powder particles from the stroke, is conserved for a longer time and can effect the sample to consolidate for a longer period after the stroke. The energy is kept inside the solid body produced. Probably is the “lifetime” for the material wave in the sample increased and can affect the sample for a longer period and more particles can melt together. The after compaction or post-compaction is performed by letting the striking unit stay in place on the solid body after the impact and press with at least the same pressure as at pre-compacting, i.e. at least about 0.25 N/m² UHMWPE. More transformations of the powder will take place in the produced body. The result is an increase of the density of the produced body by about 1-4% and is also material dependent.

When using pre-compacting and/or after compacting, it could be possible to use lighter strokes and higher pre- and/or after compacting, which would lead to saving of the tools, since lower energy levels could be used. This depends on the intended use and what material is used. It could also be a way to get a higher relative density.

To get improved relative density it is also possible to pre-process the material before the process. The powder could be pre-heated to e.g. ˜50-300° C. or higher depending on what material type to pre-heat. The powder could be pre-heated to a temperature which is close to the melting temperature of the material. Suitable ways of pre-heating may be used, such as normal heating of the powder in an oven. In order to get a more dense material during the pre-compacting step vacuum or inert gas could be used. This would have the effect that air is not enclosed in the material to the same extent during the process.

Before processing the polymer could be homogenously mixed with additives. This would means mixing in a melted condition. Predrying of the granulate could also be used to decrease the water content of the raw material. Some polymers do not absorb humidity, e.g. PE. Other polymers can easily absorb humidity which can disturb the processing of the material, and decrease the homogenity of the worked material because a high humidity rate can raise steam bubbles in the material.

The body may according to another embodiment of the invention be heated and/or sintered any time after compression or post-compacting.

Common post-processing steps are following:

1. Ionizing Radiation Treatment

Ionizing radiation treatment of the material to obtain a higher degree of cross-linking.

2. Surface Treatment

Treat the surface in different ways to obtain desired surface geometry and extra cross-linked layer in the surface which increases the wear-resistance which is a very important parameter for hip-joint application of a polymer.

Further, the body produced may be a green body and the method may also comprise a further step of sintering the green body. The green body of the invention gives a coherent integral body even without use of any additives. Thus, the green body may be stored and handled and also worked, for instance polished or cut. It may also be possible to use the green body as a finished product, without any intervening sintering. This is the case when the body is a bone implant or replacement where the implant is to be resorbed in the bone.

The polymer may be chosen from the group comprising thermoplastics, thermosetting plastics, rubber, elastomers and thermoplastic elastomers. The polymer may be a homopolymer, a copolymer, a graft copolymer or a block polymer or copolymer. As an example the material may be chosen from the group including polyolefins, such as polyethylene, polypropylene or polystyrene, polyesters, such as polyacrylics, for instance methyl methacrylic polymer, polyethers, such as polyether sulfone, urethan plastic or rubber, and polyamides.

The compression strokes need to emit a total energy corresponding to at least 100 Nm in a cylindrical tool having a striking area of 7 cm² for thermoplastics. The same value for thermosetting plastics, rubber, elastomers and thermoplastic elastomers is 100 Nm. The compression strokes need to emit an energy per mass corresponding to at least 5 Nm/g in a cylindrical tool having a striking area of 7 cm² for polymers.

It has been shown earlier that better results have been obtained with particles having irregular particle morphology. The particle size distribution should probably be wide. Small particles could fill up the empty space between big particles.

The polymer material may comprise a lubricant and/or a sintering aid. A lubricant may be useful to mix with the material. Sometimes the material needs a lubricant in the mould, in order to easily remove the body. In certain cases this could be a choice if a lubricant is used in the material, since this also makes it easier to remove the body from the mould.

A lubricant cools, takes up space and lubricates the material particles. This is both negative and positive.

Interior lubrication is good, because the particles will then slip in place more easily and thereby compact the body to a higher degree. It is good for pure compaction. Interior lubrication decreases the friction between the particles, thereby emitting less energy, and the result is less inter-particular melting. It is not good for compression to achieve a high density, and the lubricant must be removed for example with sintering.

Exterior lubrication increases the amount of energy delivered to the material and thereby indirectly diminishes the load on the tool. The result is more vibrations in the material, increased energy and a greater degree of inter-particular melting. Less material sticks to the mould and the body is easier to extrude. It is good for both compaction and compression.

An example of a lubricant is Acrawax C, but other conventional lubricants may be used. If the material will be used in a medical body, the lubricant need to be medically acceptable, or it should be removed in some way during the process.

Polishing and cleaning of the tool may be avoided if the tool is lubricated and if the powder is preheated.

In some cases it may be necessary to use a lubricant in the mould in order to remove the body easily. It is also possible to use a coating in the mould. The coating may be made of for example TiNAl or Balinit Hardlube. If the tool has an optimal coating no material will stick to the tool parts and consume part of the delivered energy, which increase the energy delivered to the powder. No time-consuming lubricating would be necessary in cases where it is difficult to remove the formed body.

A very dense material, and depending on the material, a hard material will be achieved, when the polymer material is produced by coalescence. The surface of the material will be very smooth, which is important in several applications.

If several strokes are used, they may be executed continually or various intervals may be inserted between the strokes, thereby offering wide variation with regard to the strokes.

For example, one to about six strokes may be used. The energy level could be the same for all strokes, the energy could be increasing or decreasing. Stroke series may start with at least two strokes with the same level and the last stroke has the double energy. The opposite could also be used. A study of different type of strokes in consecutive order is performed in one Example.

The highest density is obtained by delivering a total energy with one stroke. If the total energy instead is delivered by several strokes a lower relative density is obtained, but the tool is saved. A multi-stroke can therefore be used for applications where a maximum relative density is not necessary.

Through a series of quick impacts a material body is supplied continually with kinetic energy which contributes to keep the back and forth going wave alive. This supports generation of further deformation of the material at the same time as a new impact generates a further plastic, permanent deformation of the material.

According to another embodiment of the invention, the impulse, with which the striking unit hits the material body, decreases for each stroke in a series of strokes. Preferably the difference is large between the first and second stroke. It will also be easier to achieve a second stroke with smaller impulse than the first impulse during such a short period (preferably approximately 1 ms), for example by an effective reduction of the rebounding blow. It is however possible to apply a larger impulse than the first or preceding stroke, if required.

According to the invention, many variants of impacting are possible to use. It is not necessary to use the counteracting of the striking unit in order to use a smaller impulse in the following strokes. Other variations may be used, for example where the impulse is increasing in following strokes, or only one stroke with a high or low impact. Several different series of impacts may be used, with different time intervals between the impacts.

A polymer body produced by the method of the invention, may be used in medical devices such as medical implants or bone cement in orthopaedic surgery, instruments or diagnostic equipment. Such implants may be for examples skeletal or tooth prostheses.

According to an embodiment of the invention, the material is medically acceptable. Such materials are for example suitable polymers, such as UHMWPE and PMMA.

A material to be used in implants needs to be biocompatible and haemocompatible as well as mechanically durable, such as UHMWPE and PMMA or other suitable polymers.

Other polymers which may be used according to the invention are elastomers and thermoplastic elastomers.

The body produced by the process of the present invention may also be a non medical product such as sinks, baths, displays, glazing (especially aircraft), lenses and light covers.

Here follows several applications for some of the materials. Applications for PMMA include sinks, baths, displays, glazing (especially aircraft), lenses and light covers. PMMA is a well known biomaterial and used as bone cement in orthopaedic surgery and a well known biomaterial. UHMWPE is a common material within the implants industry. The most common application is the acetabulum, which is in contact with the hip ball. The invention thus has a big application area for producing products according to the invention.

When the material inserted in the mould is exposed to the coalescence, a hard, smooth and dense surface is achieved on the body formed. This is an important feature of the body. A hard surface gives the body excellent mechanical properties such as high abrasion resistance and scratch resistance. The smooth and dense surface makes the material resistant to for example corrosion. The less pores, the larger strength is obtained in the product. This refers to both open pores and the total amount of pores. In conventional methods, a goal is to reduce the amount of open pores, since open pores are not possible to get reduced by sintering.

It is important to admix powder mixtures until they are as homogeneous as possible in order to obtain a body having optimum properties.

A coating may also be manufactured according to the method of the invention. One polymer coating may for example be formed on a surface of a polymerlic element of another polymer or some other material. When manufacturing a coated element, the element is placed in the mould and may be fixed therein in a conventional way. The coating material is inserted in the mould around the element to be coated, by for example gas-atomizing, and thereafter the coating is formed by coalescence. The element to be coated may be any material formed according to this application, or it may be any conventionally formed element. Such a coating may be very advantageously, since the coating can give the element specific properties.

A coating may also be applied on a body produced in accordance with the invention in a conventional way, such as by dip coating and spray coating.

It is also possible to first compress a material in a first mould by at least one stroke. Thereafter the material may be moved to another, larger mould and a further polymer material be inserted in the mould, which material is thereafter compressed on top of or on the sides of the first compressed material, by at least one stroke. Many different combinations are possible, in the choice of the energy of the strokes and in the choice of materials.

The invention also concerns the product obtained by the methods described above.

The method according to the invention has several advantages compared to pressing. Pressing methods comprise a first step of forming a green body from a powder containing sintering aids. This green body will be sintered in a second step, wherein the sintering aids are burned out or may be burned out in a further step. The pressing methods also require a final working of the body produced, since the surface need to be mechanically worked. According to the method of the invention, it is possible to produce the body in one step or two steps and no mechanical working of the surface of the body is needed.

When producing a prothesis according to a conventional process a rod of the material to be used in the prothesis is cut, the obtained rod piece is melted and forced into a mould sintered. Thereafter follows working steps including polishing. The process is both time and energy consuming and may comprise a loss of 20 to 50% of the starting material. Thus, the present process where the prothesis may be made in one step is both material and time saving. Further, the powder need not be prepared in the same way as in conventional processes.

By the use of the present process it is possible to produce large bodies in one piece. In presently used processes involving casting it is often necessary to produce the intended body in several pieces to be joined together before use. The pieces may for example be joined using screws or adhesives or a combination thereof.

A further advantage is that the method of the invention may be used on powder carrying a charge repelling the particles without treating the powder to neutralize the charge. The process may be performed independent of the electrical charges or surface tensions of the powder particles. However, this does not exclude a possible use of a further powder or additive carrying an opposite charge. By the use of the present method it is possible to control the surface tension of the body produced. In some instances a low surface tension may be desired, such as for a wearing surface requiring a liquid film, in other instances a high surface tension is desired.

Here follow some Examples to illustrate the invention.

### EXAMPLES

Three polymers were chosen for investigation. Two are thermoplastics and of these one is semi-crystalline, UHMWPE with approximately 50% amorphous content. The second thermoplastic polymer, PMMA, is pure amorphous. The third polymer is an acrylonitrilie-butadiene rubber premixed with vulcanisation aids. The UHMWPE and the PMMA both have a big application area within the biomaterial industry.

The main objective of the study in Example 1 was to map the relation between impact energy and the density of the body produced with the aim to to obtain a relative density of >95%. In that case desired material properties could possibly be obtained without further post-processing. If a relative density of close to 100% is obtained after this manufacturing process, several manufacturing steps could be cut comparing with conventional manufacturing methods.

In Example 2 parameter studies were performed. Different parameters were varied to investigate how they could be used to obtain the best result depending on the desired properties of a product. A weight study (A), velocity study (B), time interval study (C), energy study (D) and number of strokes study (E) were performed, but only for one chosen material type, UHMWPE, which would represent the parameters' behaviour of the material group of polymers. The objective of these investigations were to determine how the different parameters effect the result and to get a knowledge on how the parameters influence material properties.

Preparation of the Powder

The preparation was the same for all the polymers, if nothing else is said.

The polymers tested herein are pure powders except for the rubber which has vulcanisation aid added. All powders are initially dry-mixed for 10 minutes to obtain a homogeneous particle size distribution.

Description

The first sample in all four batches included in the energy and additives studies was only pre-compacted once with a 117680 N axial load. The following samples were first pre-compacted and thereafter compacted with one impact stroke. The impact energy in this series was between 150 and 3100 Nm (some batches stopped at a lower impact energy), and each impact energy step interval was 150 Nm or 300 Nm depending on the batch number.

In A (weight study), the impact energy interval was from 300 to 3000 Nm with 300 Nm of impact step interval. The only parameter that was varied was the weight of the sample. It rendered different impact energies per mass.

In B (velocity study), the impact energy interval was from 300 to 3000 Nm with 300 Nm of impact step interval as well. But here different stroke units (weight difference) were used to obtain different maximum impact velocities.

In C and E (time interval study and number of strokes study) the total impact energy level was either 1200 Nm or 2400 Nm. Sequences of two to six strokes were investigated. Prior to the impact stroke sequence the specimens were pre-compacted using a static axial pressure of 117680 N. The time interval between the strokes in a sequence was 0.4 or 0.8 s.

In D (energy study) five different stroke profile sequences were investigated, “Low-High”, “High-Low”, “Stair case up”, “Stair case down”, and “Level”. In the “Low-High” sequence, the final stroke in the sequence is twice the energy level of the sum of the equi level former strokes. Hence, the “High-Low” sequence is the mirror sequence with an initial high impact energy stroke. The stair case up and down sequences are stepwise increasing or decreasing energy levels in the sequence. All increases or decreases of steps in a sequence are the same. The “Level” sequence is performed with each stroke at the same impact energy level.

After each sample had been manufactured all tool parts were dismounted and the sample was released. The diameter and thickness were measured with electronic micrometers which rendered the volume of the body. Thereafter the weight was established with a digital scale. All input values from micrometers and scale were recorded automatically and stored in separate documents for each batch. Out of these results the density 1 was obtained by taking the weight divided by the volume.

To be able to continue with the next sample, the tool needed to be cleaned, either only with acetone or by polishing the tool surfaces with an emery cloth to get rid of the material rests on the tool.

To easier establish the state of a manufactured sample three visibility indexes are used. Visibility index 1 corresponds to a powder sample, visibility index 2 corresponds to a brittle sample and visibility index 3 corresponds to a solid sample.

The theoretical density is either taken from the manufacturer or calculated by taking all included materials weighed depending on the percentage of the specific material. The relative density is obtained by taking the obtained density for each sample divided by the theoretical density.

Density 2, measured with the buoyancy method, was performed with all samples. Each sample was measured three times and with that three densities were obtained. Out of these densities the median density was taken and used in the figures. First the dry weight of the samples was determined (m₀). and thereafter the buoyancy was measured in water (m₁). With m₀ and m₂ and the temperature of the water, the density 2 was determined.

Sample Dimensions

The dimensions of the manufactured sample in these tests are a disc with a diameter of ˜30.0 nun and a height between 5-10 mm. The height depends on the obtained relative density. If a relative density of 100% would be obtained the thickness would be 5.00 mm for all polymer types.

In the moulding die (part of the tool) a hole with a diameter of 30.00 mm is drilled. The height is 60 mm. Two stamps are used (also parts of the tool). The lower stamp is placed in the lower part of the moulding die. Powder is filled in the cavity that is created between the moulding die and the lower stamp. Thereafter, the impact stamp is placed in the upper part of the moulding die and the tool is ready to perform strokes.

### Example 1

Table 1 shows the properties for the polymer types used.

TABLE 1

| | | | Nitrile |
|---|---|---|---|
| Properties | UHMWPE | PMMA | Rubber |
| 1. Particle size (micron) | <150 | <600 | <1 mm |
| 2. Particle distribution (micron) | — | — | — |
| 3. Particle morphology | Irregular | Irregular | Irregular |
| 4. Powder polymerisation | — | — | — |
| 5. Crystal structure | 50% | a- | amorphous |
| | amorphous | morphous | |
| 6. Theoretical density (g/cm³) | 0.94 | 1.19 | 0.99 |
| 7. Apparent density (g/cm³) | 50 | 60 | — |
| 8. Melt temperature (° C.) | 125 | 125 | |
| 9. Sintering temperature (° C.) | — | — | — |
| 10. Hardness (Rockwel) | M92-100 | R50-70 | — |

Table 2 shows the test results and the testing energy span. The density 1 method is used to establish the relative density.

TABLE 2

| Properties | UHMWPE | PMMA | Nitrile Rubber |
|---|---|---|---|
| Sample mass (g) | 4.2 | 4.2 | 3.5 |
| number of samples made | 17 | 31 | 7 |
| Energy step intervals (Nm) | 150 | 150 | 300 |
| Relative density at pre- | 76.7 | powder | 100 |
| compacting (%) | | | |
| Maximum energy (Nm) | 2700 | 3150 | 2100 |
| Energy per mass at | 643 | 750 | 600 |
| maximum density (Nm/g) | | | |
| Maximum relative density (%) | 99.7 | 97.1 | 103.8 |
| Impact energy per mass at | 643 | 750 | 171 |
| maximum density (Nm/g) | | | |

Ultra High Molecular Weight Polyethylene (UHMWPE), from Goodfellow

The powder specified in Table 3 was used.

TABLE 3

| Properties | Values |
|---|---|
| 1. Particle size | Average 150 micron |
| 2. Particle distribution | 5-10 wt % < 180 micron |
| | 45 wt % 125-180 micron |
| | 35 wt % 90-125 micron |
| | 10-15 wt % < 90 micron |
| 3. Particle morphology | Irregular |
| 4. Powder production | Polymerised |
| 5. Type of polymer | Thermoplastic |
| 6. Theoretical density (g/cm³) | 0.94 |
| 7. Apparent density (g/cm³) | 0.4 |
| 8. Melt temperature | 125° C. |
| 9. Hardness (Rockwell) | 50-70 |

The first sample was only pre-compacted with an axial load of 117680 N. The following 16 samples were initially pre-compacted and thereafter compacted with one impact stroke. The impact energy in this series ranged from 150 to 2700 Nm, with a 150 Nm impact step interval.

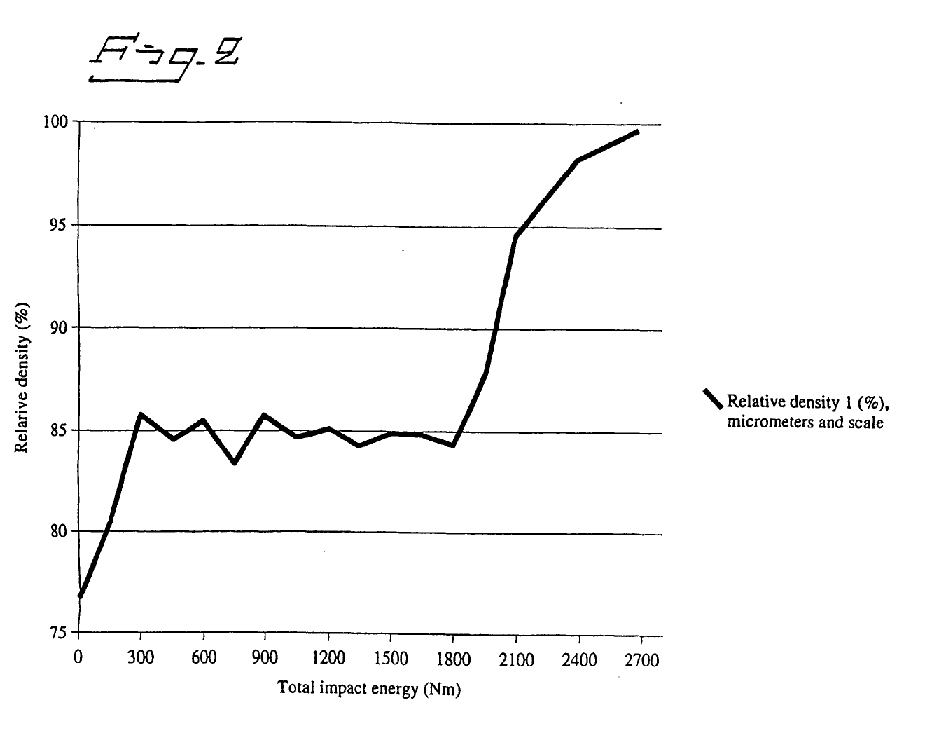

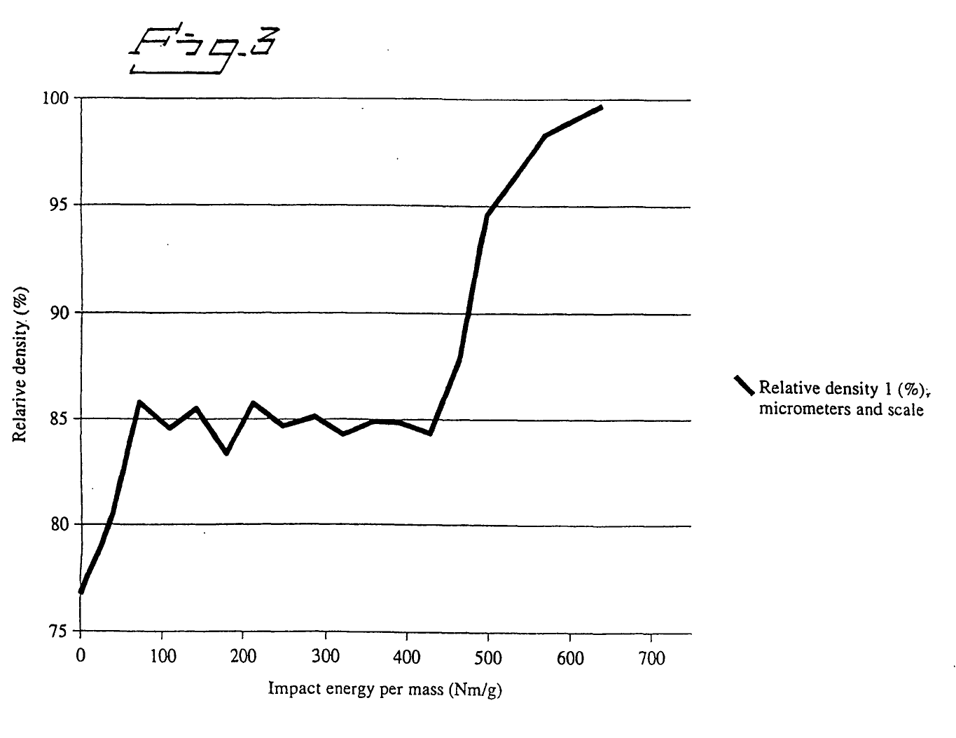

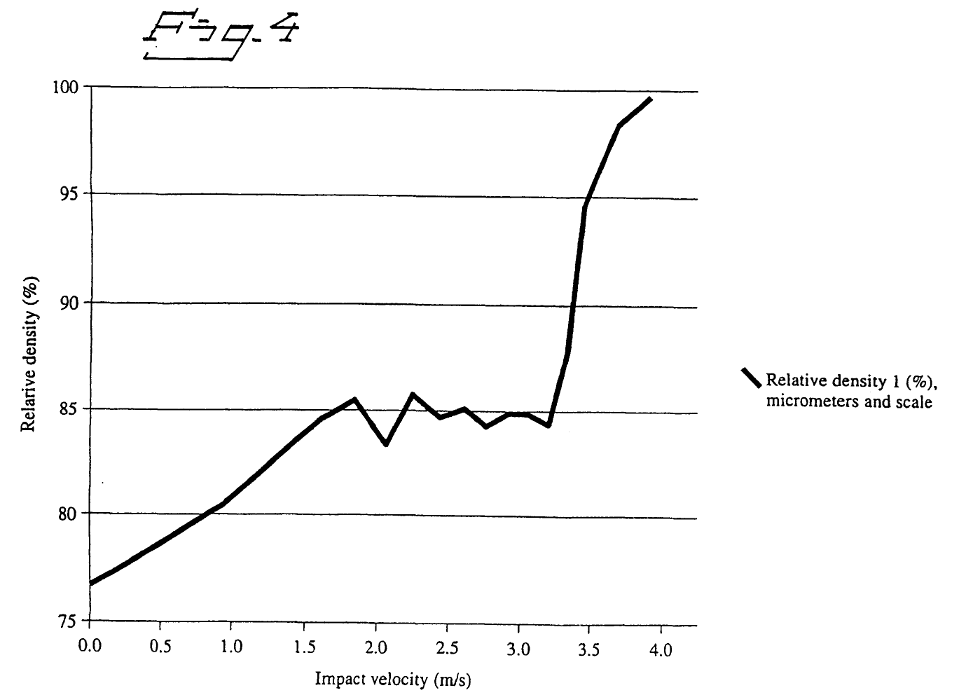

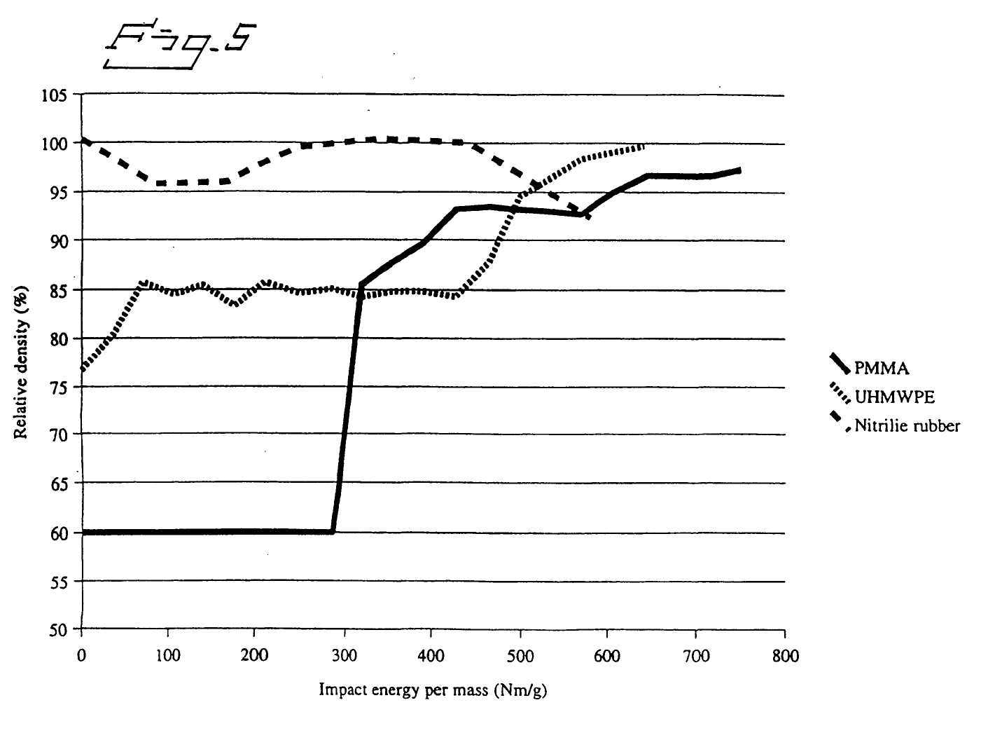

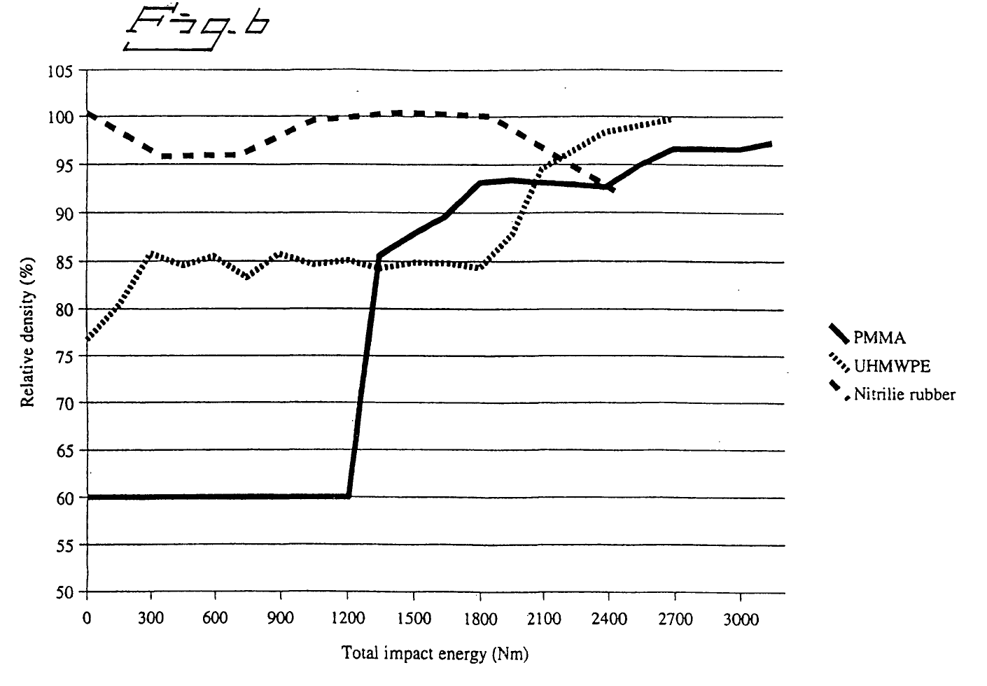

The results obtained are shown in the above Table 2. In FIGS. 2-4 the relative density is shown as a function of the total impact energy, of the impact energy per mass and of the impact velocity for UHMWPE. FIGS. 5 and 6 show the relative density as a function of impact energy per mass and of total impact energy, respectively, for all three polymers tested. The following described phenomena could be seen for all curves.

All samples between the pre-compacting and 1950 Nm (455 Nm/g, 3.34 m/s) had visibility index 2. At 2100 Nm (636 Nm/g, 3.46 m/s) the powder transformed to a sample with visibility index 3.

All samples held together when they were pushed out of the mould. When striking samples no 15, 16 and 17 a different impact sound was herd at the impact. Grey smoke came out of the tool. When inspecting the tool, material had been pressed out between the stamp and the moulding die. The sample was extremely hard to push out due to the material between the stamp and the die. That material consisted of a thin plastic film attached to the sample. The sample itself had areas of opaque material but also plastic shining parts with fat surfaces. Evidently a phase change of the material structure has occurred.

The first curve phase, “compacting phase”, corresponds to the samples where the relative density increases from 77 to 85%. Thereafter the relative density stays constant from 300 (71 Nm/g, 1.3 m/s) to 1800 Nm (429 Nm/g, 3.2 m/s), 85%, the “plateau phase”. From 1950 Nm (466 Nm/g, 3.34 m/s) the relative density increases again and at 2700 Nm (641 Nm/g, 3.9 m/s) the obtained relative density is 99.7%. This new increase of the relative density is the “reaction phase”.

When no external lubricant was used, no material did stick to the surface of the mould. External lubricant (Acrawax C) was used with the first samples but material got stuck on the tool and therefore the external lubricant was excluded for the rest of the samples. When samples with visibility index 2 were produced the tool did not suffer any damages or scratches and samples were easily removed from the mould.

The stamp got stuck when the material “exploded” (the reaction phase) and material got stuck between mould and impact stamp.

Polymethyl Methacrylate, (PMMA), —CH₂C(CH₃)COOCH₃-Goodfellow

PMMA is often just called acrylic-though this really describes a large family of chemically related polymers—PMMA is an amorphous, transparent and colourless thermoplastic that is hard and stiff but brittle. It has a good abrasion and UV resistance and excellent optical clarity but poor low temperature, fatigue and solvent resistances. Generally PMMA is extruded and injected moulded.

Applications include sinks, baths, displays, glazing (especially aircraft), tenses and light covers. PMMA is a well known biomaterial and used as bone cement in orthopaedic surgery and a well known biomaterial.

The first sample of PMMA powder was only pre-compacted with an axial load of 117680 N. The following 22 samples were first pre-compacted and thereafter compacted with one stroke. The impact energy in this series was between 150 and 3150 Nm, and each impact energy step interval was 150 Nm.

The results are shown in the above Table 2 and FIGS. 5 and 6.

All samples between the pre-compacting and 1350 Nm (345 Nm/g, 2.7 m/s) was still powdered samples, which corresponds to visibilty index 1. This sample had some lose attached particles that easily came off then touched. At higher energies the the colour shifted slightly from sugar white to more transparent appearance. However the single particles could easily be seen. The relative density energy graph started at a high density level when a sample first was formed and thereafter not increasing so much. The following samples were in one piece but not completely solidified and had visibility index 2, except sample number 20^{th} and 21^{st} which were solid (visibilty index 3).

The curve of the density 2 shows that the relative density increases from ˜60%, assumed apparent density of the powder, to ˜96.4%. The first whole sample was obtained at 1500 Nm which corresponds to 3.2 m/s of impact velocity and had a relative density of 93.2%. This means that the impact border where the powder transforms from powder to sample is between 0-1500 Nm, which corresponds to a impact energy level per mass of 0-430 Nm/g and 0-3.2 m/s of impact velocity.

The highest relative density was 96.4% of theoretical density at 3150 Nm (750 Nm/g and 3.9 m/s).

No external lubrication was needed in the tool. No material did stick to the surface of the mould and the tool did not suffer any damages or scratches even though the impact energy level increased. The samples were easily removed from the mould.

Rubber Nitriflex NP 2021 from Nitriflex

The material consisted of 90% acrylonitrile-butadiene-copolymer and 10% CaCO₃.

The first sample was only pre-compacted with an axial load of 117680 N. The following 7 samples were initially pre-compacted and thereafter compressed with one impact stroke. The impact energy in this series was from 300 to 2100 Nm, with a 300 Nm impact step interval.

The results obtained are shown in the above Table 2 and in FIGS. 5 and 6 the relative density is shown as a function of impact energy per mass and of total impact energy, respectively. The following described phenomena could be seen for all curves.

All samples had visibility index 3.

When striking the two last strokes a lot of smoke came out from the mould. The samples got somewhat burnt with a brownish colour.

The samples were all intact, but the volume was difficult to establish because the samples were extremely elastic. The samples could easily get deformed and wrong diameter and thickness were rendered. Besides the sides, that were in contact with the moulding die, got deformed. Due to that the sides were not smooth the diameter was difficult to establish. Owing to this density 1 sometimes exceeded 100% of relative density.

Inspecting the curves in FIGS. 5-6, the densities (density 2) exceed 100%. Already after the pre-compacting 100% was obtained. One possible reason could be that the theoretical density of rubber and water is similar. That could probably cause faulse values.

No material did stick to the surface of the mould even though external lubricant was not used. The tool did not suffer any damages or scratches. The samples were easily removed from the mould. However, the stamp got stuck when the material got somewhat burnt and material got stuck between mould and impact stamp.

### Example 2

In the following parameter studies performed on UHMWPE are described. UHMWPE is a semi-crystalline, whitish and effectively opaque engineering thermoplastic which has a very high molecular weight. As a result it has an extremely high melt viscosity and it can normally only be processed by powder sintering methods. It also has outstanding toughness and cut and wear resistance and very good resistance.

UHMWPE is a common material within the implants industry. The most common application is the acetabulum, which is in contact with the hip ball.

Energy Study (C-D)

An energy study was performed using multi stroke sequences where each stroke had an impact energy of either 1200 or 2400.

Sequences of two to six strokes were investigated. The material used was pure UHMWPE powder. Prior to the impact stroke sequence the specimen were pre-compacted using a static axial pressure of 117680 N. The time interval between the strokes in a sequence was 0.4 or 0.8 s. Five different stroke profile sequences were investigated, “Low-High”, “High-Low”, “Stair case up”, “Stair case down”, and “Level”. In the “Low-High” sequence, the final stroke in the sequence is twice the energy level of the sum of the equilevel former strokes. Hence, the “High-Low” sequence is the mirror sequence with a initial high energy stroke. The stair case up and down sequences are stepwise increasing or decreasing energy levels in the sequence. All increases or decreases of steps in a sequence are the same. The “Level” sequence is performed with each stroke at the same energy level.

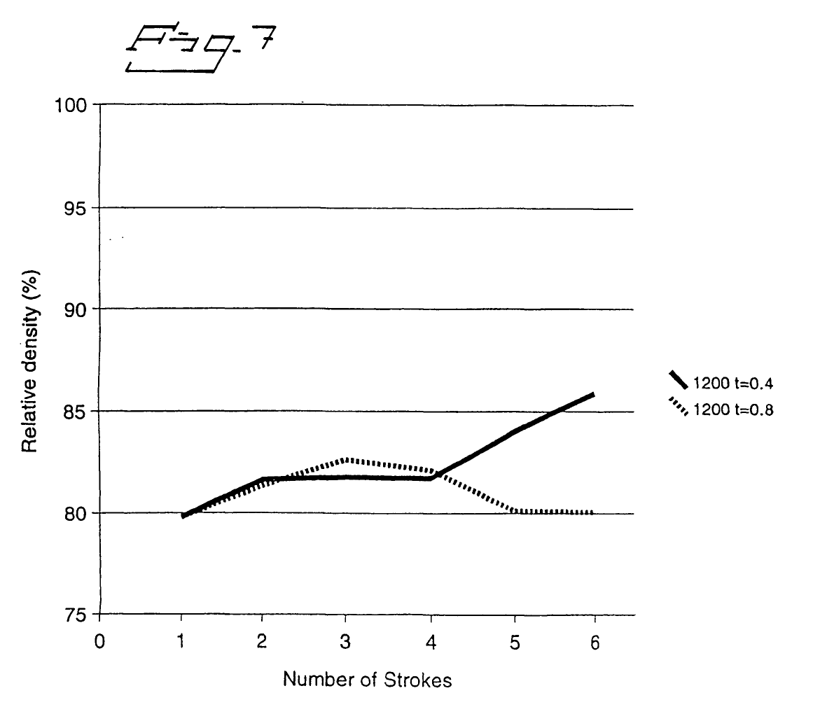

The results obtained are shown in Table 4 and FIGS. 7-12.

TABLE 4

| | |
|---|---|
| Sample weight (g) | 4.2 |
| Number of samples made | 94 |
| Minimum total impact energy (Nm) | 1200 |
| Maximum total impact energy (Nm) | 2400 |
| Minimum impact energy per mass (Nm/g) | 286.0 |
| Maximum impact energy per mass (Nm/g) | 571.0 |
| Maximum relative density 2 (%) | 93.6 |
| Maximum density obtained for 2400 Nm, one stroke | 93.6 |

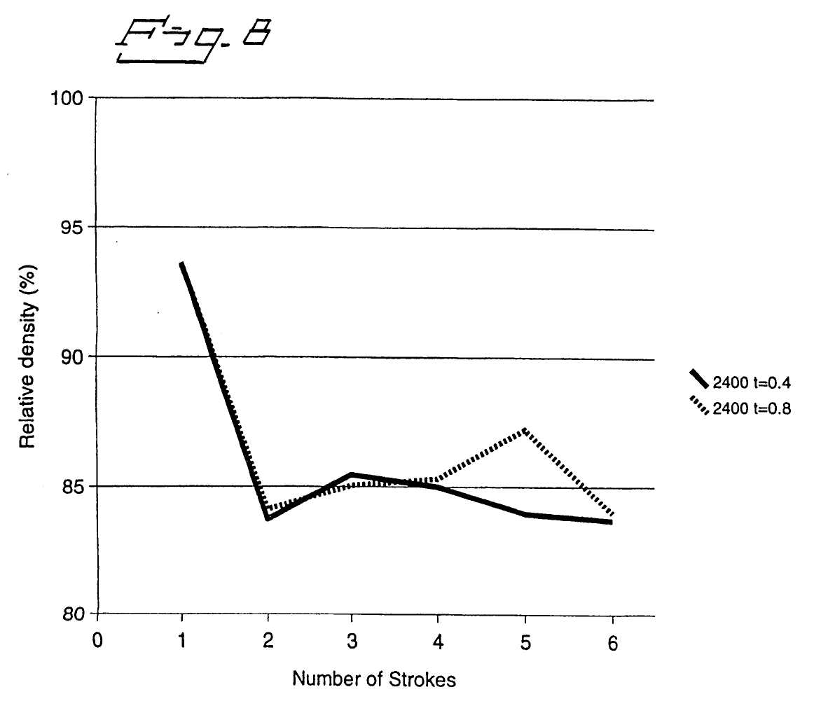

FIG. 7 and FIG. 8 show the level strokes sequences of 1200 and 2400 Nm, respectively. Each energy level is performed for both the time between the strokes of t₁=0.4 s and t₂=0.8 s. Studying the FIG. 7 it is clear that the two curves follow each other until 5 strokes, where the relative density increases for t=0.4 s. The highest obtained density was 86.2% at 5 strokes for t=0.4 and 82.7% at 3 strokes for t=0.8. For t=0.8 the increasing number of strokes do not effect the relative density noticeably. For the 2400 Nm energy level, FIG. 8, both the t=0.4 s and the t=0.8 s interval sequences indicate a decreasing density with the number of strokes. The two curves follow each other until 5 strokes, where the t=0.8 curve increases in relative density. However, the highest obtained relative density for the two curves is 93.6% which is obtained for one single stroke. The curves in FIG. 8 confirms even more that an increase in the number of strokes does not result in a higher relative density for an UHMWPE powder.

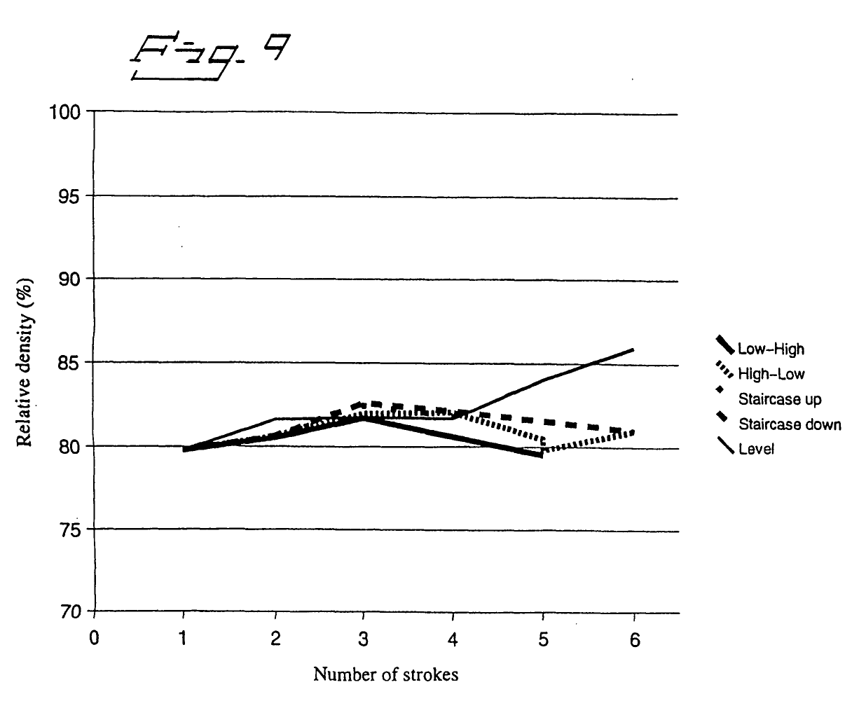

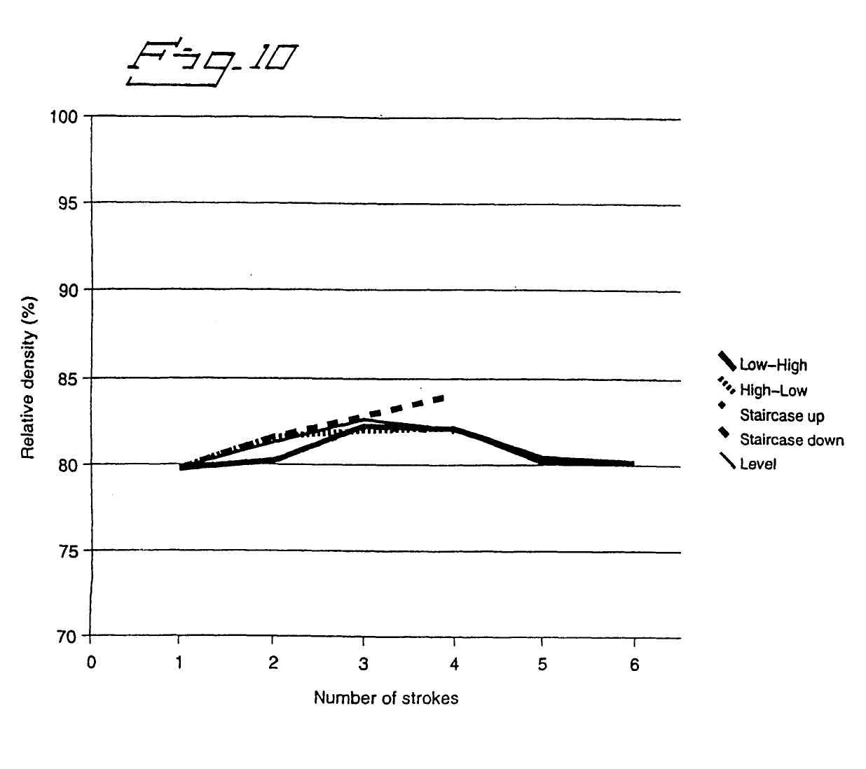

FIGS. 9 to 12 show the different stroke profiles divided into the two energy levels, 1200 and 2400 Nm, and the time intervals of t=0.4 and 0.8 s. The “Stair case” sequences were limited to two, three and four stroke sequences due to the limitations of the HYP machine programme of four individual stroke settings. FIG. 9 shows the sequences with a total energy of 1200 Nm and the time interval of 0.4 s. Generally for FIGS. 9 and 10 the obtained relative density stays stable and seems not be affected by different stoke series, except for the level curve in FIG. 9. The highest obtained relative density was 86.2%.

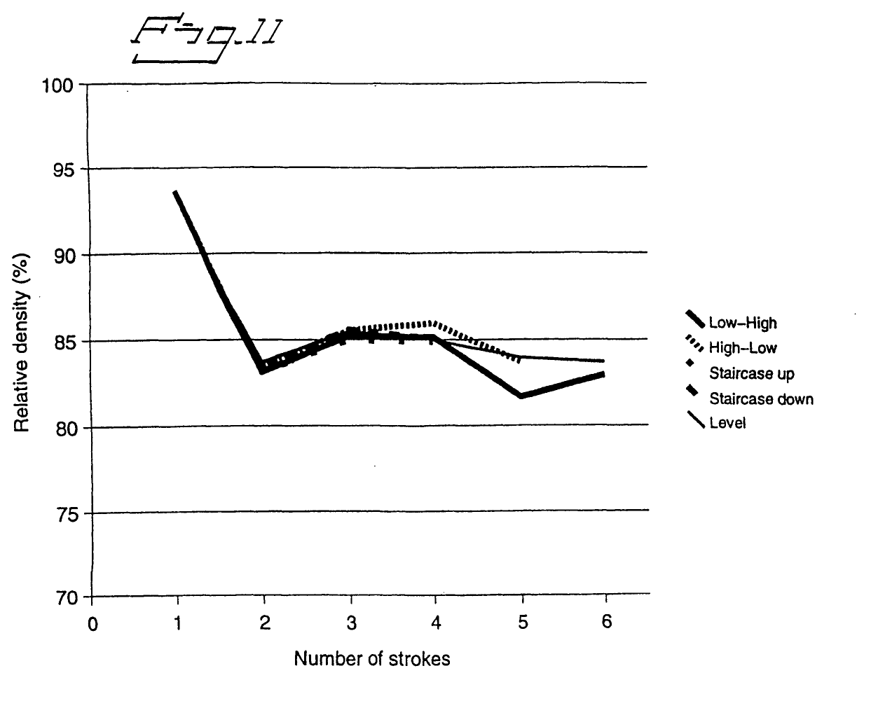

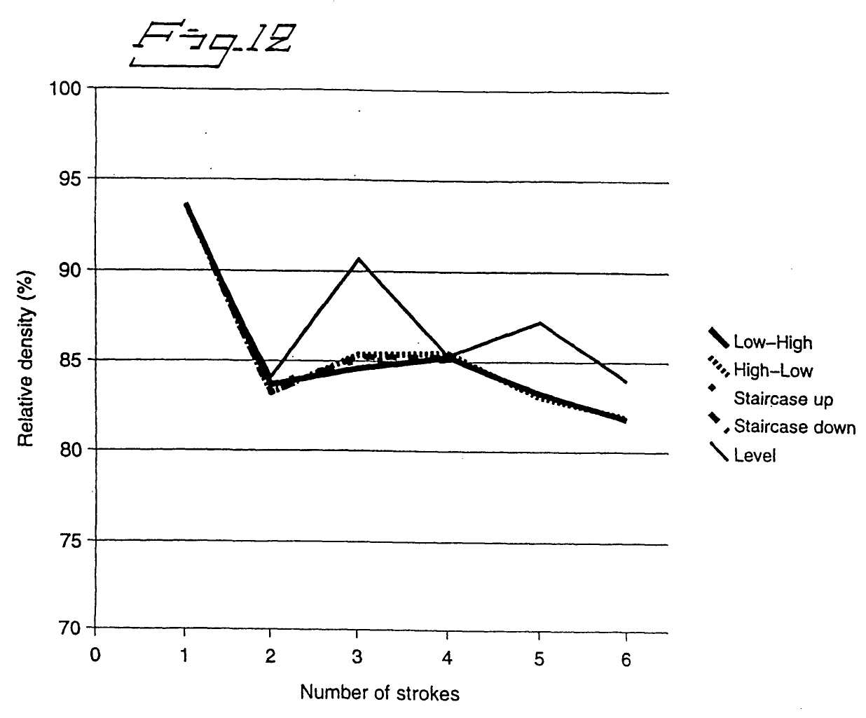

FIGS. 11 and 12 show a decrease in relative density with an increase in number of strokes. The “Level” curve for 2400 Nm and t=0.8 is very irregular. The highest relative density, 93.6%, was obtained with a single stroke at 2400 Nm.

All curves has only five measuring points. The irregularity in the level curves can be due to measuring faults.

The results shows a clear tendency that an increase in number of strokes or changes in energy levels among the strokes in a test series do not increase the relative density for a polymer powder.

Even though there is no increase in relative density it can be interesting to study the microstructure and different mechanical properties for a sample struck with one stroke and a sample struck several times. None of the samples were completely plasticised which indicates that the total energy level should be increased to obtained a more representative curve for the polymer.

Weight Study (A)

In this study, the impact energy interval was from 300 to 3000 Nm with a 300 Nm impact step interval. The only parameter that was varied was the weight of the sample. It rendered different impact energies per mass.

UHMWPE powder was compacted using the HYP 35-18 impact machine for three series of three different sample weights; 2.1, 4.2, 8.4 and 12.6 g. The 4.2 g sample series is the series described in Example 1 for UHMWPE. The 2.1 g, 8.4 g and the 12.6 g samples correspond to half, double and triple the weight of the 4.2 g sample. The series were performed with a single stroke. The 4.2 g sample series were increased in steps of 150 Nm going from only pre-compacting to maximum 3000 Nm. The half weight and the double weight series were performed with increased energy level in steps of 300 Nm ranging from 300 to 3000 Nm for the double weight series and 300 to 1800 Nm for the half weight series. All samples per pre-compacted prior to the impact stroke. The limitation in maximum energy for the half weight series was due to the limitation of the moulding die strength for energies above 1800 Nm.

The maximum and minimum energies are compiled in Table 5 together with the obtained densities. The results are also shown in FIGS. 13 and 14.

TABLE 5

| | Sample mass | | | |
|---|---|---|---|---|
| | m = 2.1 g | m = 4.2 g | m = 8.4 g | m = 12.6 g |
| Number of samples made | 6 | 22 | 10 | 8 |
| Relative density 1 at pre-compacting (%) | powder | 76.7 | 80.8 | 80 |
| Minimum total impact energy (Nm) | 300 | 150 | 300 | 300 |
| Maximum total impact energy (Nm) | 1800 | 3000 | 3000 | 2100 |
| Minimum impact energy per mass (Nm/g) | 142 | 37 | 36 | 23 |
| Maximum impact energy per mass (Nm/g) | 857 | 570 | 358 | 179 |
| Maximum relative density 1 (%) | 95.1 | 95.2 | 98.9 | 90.4 |
| Impact energy per mass at maximum density (Nm/g) | 857 | 570 | 358 | 179 |

In FIG. 13 the four test series are plotted for relative density as a function of impact energy per mass. The curves of a smaller mass is shifted to the right or to higher energy in the density energy graph. Also a shift towards lower densities could be observed for the lower sample masses. This could indicate that a higher density is obtained when the sample mass is increased for a given energy level per mass. Hence, the maximum density is reached at a lower impact energy per mass for a heavier sample. The maximum relative densities reached are given in Table 5. The difference between the maximum densities for the three series with masses 4.2, 8.4 and 12.6 g are small and therefore it could not be concluded that a higher density is obtained for any of the series when the curve has reached a maximum. However, the results show that a higher density is obtained when the sample mass is increased for a given impact energy per mass. The results show that this method demands less energy per mass for a body with a higher mass than for a body with a lower mass.

Studying the individual density-energy graph, it could be divided into three phases. Phase 1 could be characterised as the compacting phase, phase 2 would be characterised as the plateau phase and phase 3 characterised as the reaction phase. In the compaction phase, the density-energy curve follows a logarithmic relation with an initial high compaction rate. The sloop decreases as the energy is increased and eventually the curve reaches the plateau phase. The plateau phase is characterised by an almost constant inclination and constant density. At a certain energy level the density starts to incrase again. This part of the curve is non linerar with an initial positive and increasing derivative. The curve derivative is eventually decreasing and the curve is approaching the 100% relative density asymptotically. The samples of phase 1 and 2 are characterised by opaque and brittle properties. Entering phase 3, the samples gradually change properties. A new material phaseappears, first at the outer edges and at the top and bottom end surfaces. This material phase is characterised as harder, transparent and with a plastic and fat surface feeling. For the smaller mass samples the reaction does not occur gradually but rather direct. The process in phase 3 was also somewhat dramatic and could be described as a small explosion. Directly after the impact stroke, white smoke was observed coming from the sample, and material had extruded out between the stamps and the moulding die. Further, the pressure occurring at the reaction phase proved to be very high when during one test the moulding die was cracked open. A larger weight sample proved to be compacted faster at lower energy per mass levels and the reaction shift of material phase is occurring gradually rather than direct as for the small samples. The limited test series of the 12.6 g was due to the limited powder pillar height of the tool. The insertion distance was less than the recommended distance of the 30 mm (diameter of stamp). The test was therefore stopped at the impact energy of 2100 Nm to eliminate a tool failure. The two large dips in density for the 8.4 g sample depends on the sample not holding together and coming out as a powder.

Thus, a higher density is obtained when increasing the sample mass for a given energy level per mass and the slope of the density energy curve is increasing as the energy exceeds a certain value.

Velocity Study (B)

UHMWPE powder was compacted using the HYP 35-18, HYP 36-60 and a high velocity impact machine. For the high velocity impact machine the impact ram weight could be changed and five different masses were used; 7.5, 11.8, 14.0, 17.5 and 20.6 kg. The impact ram weight for the HYP 35-60 is 1200 kg and for the 35-18 it is 350 kg. The sample weight was 4.2 g. The sample series performed with the HYP 35-18 machine is described in “Material type report: UHMWPE”. All samples were performed with a single stroke. The series were performed for energies increasing in steps of 300 Nm ranging from pre-compacting to a maximum of 3000 Nm. All samples were also pre-compacted before the impact stroke. The pre-compacting force for the HYP 35-18 was 135 kN, for the HYP 35-60 it was 260 kN and for the high velocity machine 18 kN. The highest impact velocity 28.3 m/s was obtained with the 7 kg impact ram and the slowest impact velocity, 2.2 m/s, is obtained with the impact ram mass 1200 kg, HYP 35-60 machine, for the maximum energy level of 3000 Nm.

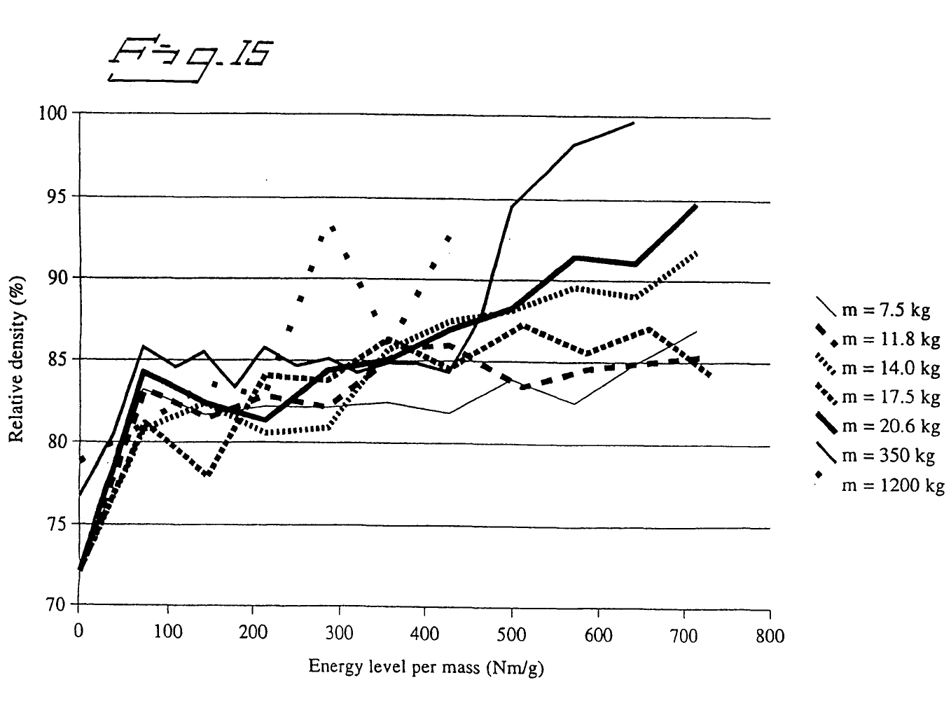

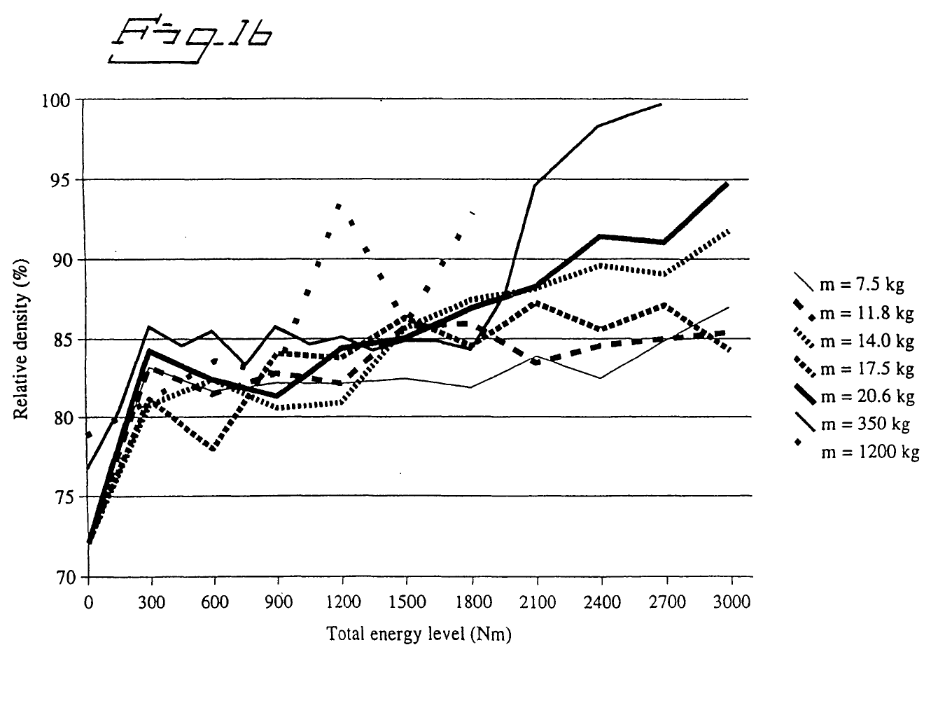

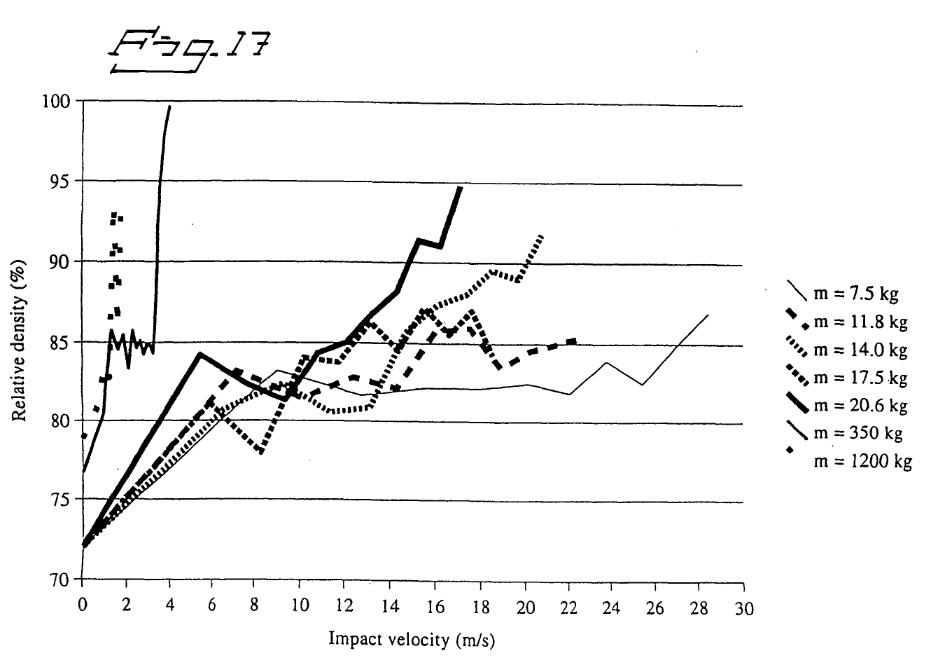

In FIG. 15 the seven test series are plotted for relative density as a function of energy level per mass. The maximum relative densities reached are given in Table 6. FIG. 16 shows the relative density as a function of total impact energy and FIG. 17 shows the relative density as a function of impact velocity. The results indicate that a higher density is obtained when the impact ram mass is increased or equivalent a decreased impact velocity for a given energy level per mass. The effect is decreased as the energy is increased.

The relative density at pre-compacting is to a great extent dependent on the static pressure. The pre-compacted samples for the 7.5 to 20.6 kg impact rams as well as for the 350 and 1200 kg impact rams were not transformed to solid bodies, but to bodies easily breakable and brittle and described herein as visibility index 2. The relative density for the samples produced with 18 kN pre-compacting force was 72.1%. For the 135 kN and 260 kN pre-compacting force the density increased to 76.7 and 78.8%, respectively. These results show the importance of pre-compaction for the total compaction result of the material. For the low impact energies of approximately 300 to 1200 Nm there are only small differences in density for the samples produced with the different impact rams or at different impact speeds, see FIG. 15 and FIG. 16. At higher energies the curves begin to separate. The curves of the high impact ram weights, i.e. 350 and 1200 kg, increase in density faster and at lower energies than for the low impact weight curves. Consequently, a low impact speed gives a higher density compared to a high impact speed at the same energy level.

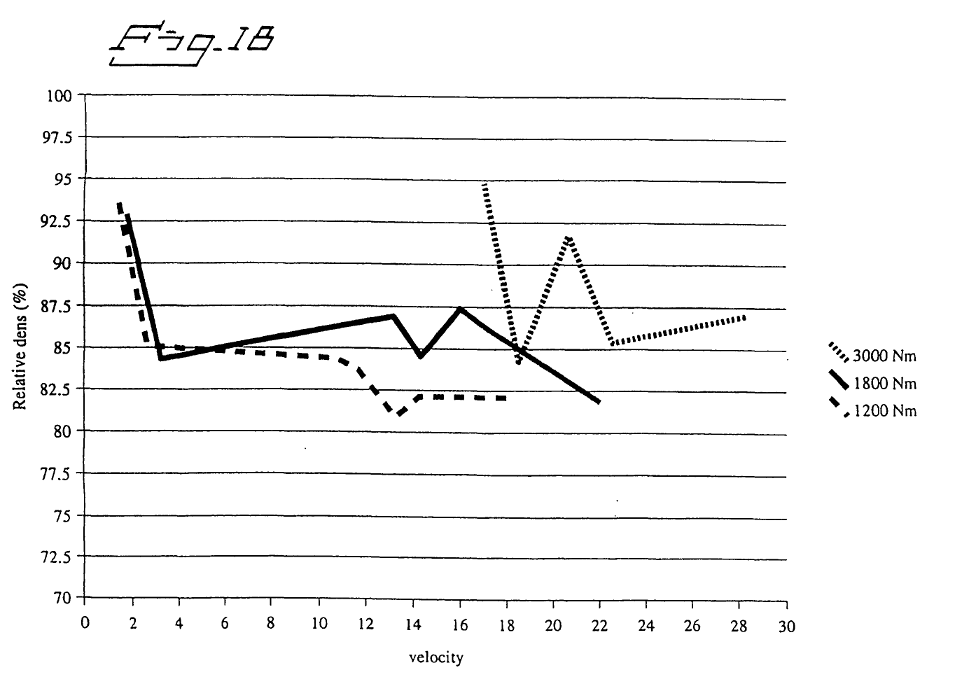

FIG. 18 shows the relative density as a function of impact velocity at three different total impact energy levels; 3000, 1800 and 1200 Nm. The Figure indicates that the relative density increases as the impact velocity decreases or equivalent, the impact ram weight increases.

TABLE 6

| | Machine ram weight (kg) | | | | | | |
|---|---|---|---|---|---|---|---|
| | 7.5 | 11.8 | 14 | 17.5 | 20.6 | 350 | [symbol] |
| Sample weight (g) | 4.2 | 4.2 | 4.2 | 4.2 | 4.2 | 4.2 | |
| Number of samples made | 11 | 10 | 11 | 10 | 11 | 17 | |
| Relative density at pre-compacting (%) | 72.1 | 72.1 | 72.1 | 72.1 | 72.1 | 76.7 | |
| Minimum total impact energy (Nm) | 300 | 300 | 300 | 300 | 300 | 150 | |
| Maximum total impact energy (Nm) | 3000 | 3000 | 3000 | 3000 | 3000 | 2700 | [symbol] |
| Minimum impact energy per mass (Nm/g) | 71 | 71 | 71 | 71 | 71 | 37 | |
| Maximum impact energy per mass (Nm/g) | 714 | 714 | 714 | 714 | 714 | 641 | |
| Relative density at first produced body (%) | 72.1 | 72.1 | 72.1 | 72.1 | 72.1 | 76.7 | |
| Impact energy at first produced body (Nm) | 0 | 0 | 0 | 0 | 0 | 0 | |
| Maximum impact velocity (m/s) | 28.3 | 22.6 | 20.7 | 18.5 | 17.1 | 4.1 | |
| Maximum relative density (%) | 87.0 | 85.4 | 91.7 | 84.3 | 94.8 | 99.7 | |
| Impact energy per mass at maximum density | 714 | 714 | 714 | 714 | 714 | 641 | |
| (Nm/g) | | | | | | | |

Inspecting the density-energy curves, one could conclude that with a higher pre-compacting force a higher density can be obtained. However, observing the curves of the impact rams with masses of 7.5, 11.8, 14.0 17.5 and 20.6 kg performed in the same machine and with the same pre-compacting load, the results still gives a higher density for a lower impact velocity at the same energy level. The deviating result of the 7.5 kg impact ram could be due to the friction losses being higher when the velocity is increased.

### CONCLUSIONS

The melting temperature does not seem to have an effect on the degree of the density of the material. The UHMWPE and the PMMA have approximately the same melting temperature and the curves do not coincide. The reason for the lower densities of the PMMA may be due to differences on microstructure level. Chain configuration, chemical composition, degree of crystallinity and conformation could be parameters influencing the degree of densification at a certain energy level. Also the particles size and conformation may be such a parameter.

Due to transmitted energy a local increase in temperature occurs, and that enables the particles to soften, deform and the surface of the particles to melt. This inter-particular melting enables the particles to re-solidify together and dense material can possibly be obtained.

Furthermore, the hardness of materials effect the results. The softer a material is the more soft and deformed do the particles get. This enables the particles to get well soften, deformed and compacted before the inter-particular melting occurs.

Another pre-treating process to increase the relative density could be to pre-heat either only the powder or both the powder and the tool. The two thermoplastics could probably be pre-heated to obtain a better density but the pre-heat temperature has to be well below the melting temperature. Also evacuation of air included in the powder could increase the density of the material. This is achieved by performing the process in a vacuum chamber.

Other critical parameters, that could effect the compacting result, besides the already mentioned, melting temperature and hardness, could be the particle size, particle size distribution and particle morphology. According to earlier tests, that were performed in Phase 1, better results were obtained with an irregular particle morphology, than spherical morphology. Inter-particular melting occurred when irregular particles were tested, but not when spherical particles were tested. When irregular particles get into contact with each other, by being pressed together, the contact surface is much larger compared with spherical particles. The big contact area could possibly enable the particles to easier fuse during the process and, with this theory, less impact energy is needed to be transmitted to the powder.

If big particles are used more space is present between the particles than with small particles. That makes it harder to obtain a dense and well compacted sample. The advantage with big particles, compared with small particles, is that the total surface of bigger particles is less than with small particles. A large total surface makes the surface energy high and correspondingly higher impact energy could be required to reach desired results. On the other hand, small particles could possibly reach a higher compacted rate because the space between the particles is smaller than between large particles.

The particle size distribution should probably be wide. Small particles could fill up the empty space between big particles.

There does not seem to be an advantage in striking several strokes to obtain higher total impact energy. The same phenomenon could be determined for the impact velocity. According to D (energy study) the best result was obtained after only one stroke had been stricken. If more than one stroke was performed there will be a time interval between the strokes. The optimal time interval between the strokes should be determined in each case.

Depending on what stroke unit that is used the obtained relative density after pre-compacting process is different. According to B (velocity study) there are ˜35% difference between the obtained relative density depending on what stroke unit that has been used. A small stroke unit with a small mass rendered a lower relative density after the pre-compacting process than what a heavy stroke unit did. But the increase of the relative density is higher with a high maximum impact velocity (low stroke unit weight). The stroke unit with the lowest maximum impact velocity rendered an increase from the pre-compacting sample to the maximum relative density sample of 25%. The stroke unit with the highest maximum impact velocity had an increase of the relative density of ˜60%. The optimal solution could be to pre-compact the powder with a stroke unit with a low maximum impact velocity (heavy stroke unit) and thereafter use a stroke unit with a high maximum impact velocity (small stroke unit).

The invention concerns a new method which comprises both pre-compacting and in some cases post-compacting and there between at least one stroke on the material. The new method has proved to give very good results and is an improved process over the prior art.

The invention is not limited to the above described embodiments and examples. It is an advantage that the present process does not require the use of additives. However, it is possible that the use of additives could prove advantageous in some embodiments. Likewise, it is usually not necessary to use vacuum or an inert gas to prevent oxidation of the material body being compressed. However, some materials may require vacuum or an inert gas to produce a body of extreme purity or high density. Thus, although the use of additives, vacuum and inert gas are not required according to the invention the use thereof is not excluded. Other modifications of the method and product of the invention may also be possible within the scope of the following claims.

1. A method of producing a polymer body by coalescence, characterised in that the method comprises the steps of
a) filling a pre-compacting mould with polymer material in the form of powder, pellets, grains and the like,
b) pre-compacting the material at least once and
c) compressing the material in a compression mould by at least one stroke, where a striking unit emits enough kinetic energy to form the body when striking the material inserted in the compression mould, causing coalescence of the material.

2. A method according to claim 1, characterised in that the pre-compacting mould and the compressing mould are the same mould.

3. A method according to any of the preceding claims for producing a body of UHMWPE, characterised in that the material is pre-compacted with a pressure of at least about 0.25×10⁸ N/m², in air and at room temperature.

4. A method according to claim 3, characterised in that the material is pre-compacted with a pressure of at least about 0.6×10⁸ N/m².

5. A method according to any of the preceding claims, characterised in that the method comprises pre-compacting the material at least twice.

6. A method of producing a polymer body by coalescence, characterised in that the method comprises compressing material in the form of a solid polymer body in a compression mould by at least one stroke, where a striking unit emits enough energy to cause coalescence of the material in the body.

7. A method according to any of claims 1-5 or claim 6, characterised in that the compression strokes emit a total energy corresponding to at least 100 Nm in a cylindrical tool having a striking area of 7 cm² in air and at room temperature.

8. A method according to claim 7, characterised in that the compression strokes emit a total energy corresponding to at least 300 Nm in a cylindrical tool having a striking area of 7 cm².

9. A method according to claim 8, characterised in that the compression strokes emit a total energy corresponding to at least 600 Nm in a cylindrical tool having a striking area of 7 cm².

10. A method according to claim 9, characterised in that the compression strokes emit a total energy corresponding to at least 1000 Nm in a cylindrical tool having a striking area of 7 cm².

11. A method according to claim 10, characterised in that the compression strokes emit a total energy corresponding to at least 2000 Nm in a cylindrical tool having a striking area of 7 cm².

12. A method according to any of claim 1-5 or claim 6, characterised in that the compression strokes emit an energy per mass corresponding to at least 5 Nm/g in a cylindrical tool having a striking area of 7 cm² in air and at room temperature.

13. A method according to claim 12, characterised in that the compression strokes emit an energy per mass corresponding to at least 20 Nm/g in a cylindrical tool having a striking area of 7 cm².

14. A method according to claim 13, characterised in that the compression strokes emit an energy per mass corresponding to at least 100 Nm/g in a cylindrical tool having a striking area of 7 cm².

15. A method according to claim 14, characterised in that the compression strokes emit an energy per mass corresponding to at least 250 Nm/g in a cylindrical tool having a striking area of 7 cm².

16. A method according to claim 15, characterised in that the compression strokes emit an energy per mass corresponding to at least 450 Nm/g in a cylindrical tool having a striking area of 7 cm².

17. A method according to any of the preceding claims, characterised in that the polymer is compressed to a relative density of at least 70%, preferably 75%.

18. A method according to claim 17, characterised in that the polymer is compressed to a relative density of at least 80%, preferably 85%.

19. A method according to claim 18, characterised in that the polymer is compressed to a relative density of at least 90% to 100%.

20. A method according to any of the preceding claims, characterised in that the method comprises a step of post-compacting the material at least once after the compression step.

21. A method according to any of the preceding claims, characterised in that the polymer is chosen from the group comprising elastomers, thermoplastics, thermoplastic elastomers and thermosetting polymers.

22. A method according to claim 21, characterised in that the polymer is chosen from the group comprising polyolefines, polyesters and synthetic rubbers.

23. A method according to claim 21, characterised in that the polymer is chosen from the group comprising UHMWPE, PMMA and nitrile rubber.

24. A method according to any of the preceding claims, characterised in that the body produced is a medical implant, such as a skeletal or tooth prosthesis.

25. A method according to any of the preceding claims, characterised in that the method comprises a step of post-heating and/or sintering the body any time after the compression or the post-compacting.

26. A method according to any of the preceding claims, characterised in that the body produced is a green body.

27. A method of producing a body according to claim 27, characterised in that the method also comprises a further step of sintering the green body.

28. A method according to any of the preceding claims, characterised in that the material is a medically acceptable material.

29. A method according to any of the preceding claims, characterised in that the material comprises a lubricant and/or a sintering aid.

30. A method according to claim 6, characterised in that the method also comprises deforming the body.

31. A product obtained by the method according to any of claims 1-30.

32. A product according to claim 31, characterised in being a medical device or instrument.

33. A product according to claim 31, characterised in being a non medical device.
